(19) United States
(12) Patent Application Publication
(10) Pub. No.: US 2008/0113621 A1
(43) Pub. Date: May 15, 2008

(54) Wireless Medical Device Communication System

(76) Inventor: Jayant Parthasarathy, Hopkins, MN (US)

Correspondence Address: FULBRIGHT & JAWORSKI L.L.P., 80 SOUTH EIGHTH STREET, SUITE 2100, MINNEAPOLIS, MN, 55402, US

(21) Appl. No.: 11/936,712

(22) Filed: Nov. 7, 2007

Related U.S. Application Data
(60) Provisional application No. 60/864,778, filed on Nov. 7, 2006.

(51) Int. Cl. H04B 7/00

(52) U.S. Cl. 455/41.3

(57) ABSTRACT

The present invention is directed to a system and method which allows for the transfer of data captured by a medical device to be processed and moved to another location in accordance with pre-established criteria without requiring user interaction at the time of data capture. In one embodiment, medical data are transferred to a remote medical information terminal in accordance with pre-established guidelines. In one embodiment, the medical device determines whether data has been received at a remote information receiver and incrementally adjusts a communication parameter, such as transmit power, receive sensitivity and antenna gain/direction.

### RELATED APPLICATIONS

This application claims priority under 35 U.S.C. 119(e) from provisional U.S. Patent Application No. 60/864,778, filed Nov. 7, 2006, the contents of which are incorporated herein by reference.

### FIELD OF THE INVENTION

The present invention relates generally to wireless medical devices and more particularly to medical devices operating in an environment with widely varying signal quality.

### BACKGROUND OF THE INVENTION

Medical devices and other types of electronic devices are commonly linked to each other and to peripheral devices using a myriad of different types of cables and connectors. As these devices grow in number and variety, their cables and connectors can often become quite cumbersome to work with. Accordingly, efforts are underway to develop technologies allowing hardware connections to be replaced with wireless ones.

One such technology is the Bluetooth technology. Bluetooth refers to a technology specification for short-range radio links that allow the many proprietary cables that connect devices to one another to be replaced with short-range radio links.

Bluetooth technology is based on a high-performance, yet low-cost, integrated radio transceiver. For instance, Bluetooth transceivers built into both a cellular telephone and a laptop computer system would replace the cables used today to connect a laptop to a cellular telephone. Printers, personal digital assistants (palmtop computer systems, hand-held devices and the like), desktop computer systems, fax machines, keyboards, joysticks and virtually any other digital device can be part of a Bluetooth system. Bluetooth radio technology can also provide a universal bridge to existing data networks and a mechanism to form small private ad hoc groupings of connected devices away from fixed network infrastructures.

The Bluetooth technology allows Bluetooth devices to “discover” other Bluetooth devices that are within range and then connect with those devices, either automatically or at a user's discretion. The Generic Access Profile (GAP) of the Bluetooth specification (Section 6 of “Specification of the Bluetooth System, Core,” version 1.0B, dated Dec. 1, 1999, herein incorporated by reference as background) describes the processes by which Bluetooth devices discover each other. The device discovery process has two primary steps: an inquiry step (described in Sections 6.1 and 6.2 of the Bluetooth specification), and a name discovery step (described in Section 6.3 of the Bluetooth specification). In the inquiry step, the Bluetooth devices make their presence known to each other and exchange attributes (e.g., addresses) needed to further the connection process.

### SUMMARY OF THE INVENTION

In some environments, configurable wireless devices may be preferable to non-configurable high power wireless devices since they may facilitate reducing radio frequency energy produced in wireless computer communications. Configurable wireless devices may facilitate minimizing health risks, interference, and security risks by facilitating tailoring a signal strength to a lower power when possible, thereby conserving energy and improving the battery life of the device.

In one example, a wireless medical device may dynamically have its output signal strength reconfigured. In other examples, receiver sensitivity and/or antenna gain/direction may be reconfigured. In one example, the signal strength may be attenuated based, at least in part, on a determined proximity to a wireless monitor device with which the wireless medical device is communicating.

In one embodiment of the present invention, the received signal power is monitored and a control signal is generated to adjust a transmitter parameter, such as output power, receiver sensitivity and antenna gain/directionality. The advantages of transmitting at a reduced power level are many.

In one embodiment of the present invention, a wireless medical or fitness device (E.g. Bluetooth-enabled Pulse Oximeter, Zigbee-enabled Weight Scale, etc) determines the quality of the wireless communication link and is capable of automatically configuring a transmission range by modifying one or more of: transmit power, receive sensitivity and antenna gain/direction in order to optimize the power requirements of the device.

Wireless medical devices typically include a signal generating circuit or system, a transceiver circuit or system and an antenna system for transmitting and receiving signals. The signal strength varies between different locations and/or different times depending on, for example, transmit power, antenna directionality, and multipath fading. One approach to improving signal strength is to simply increase transmit power. For battery powered devices, such approach is not viable as it is desirable to minimize the overall load in order to increase useful battery life.

One implementation of the present invention is a wireless medical device adapted to communicate with a wireless transceiver of a control unit, monitor, or the like. By determining the quality of available communication signal(s), a device can be configured to reduce or increase a communication range in order to provide a stable and capable communication link at the lowest possible power level. In one embodiment, the transmit power of a wireless medical device is automatically configured between a lower power level (E.g. Power level A) and a higher power level (e.g. Power Level B), and a single wireless device could be used in several applications that require varied range of communication.

The output power of a transmitter in a radio-frequency communication system of the present invention is based upon the transmission objectives set forth for the system. These may be derived from grade-of-service analyses of the results of subjective and objective tests.

One aspect of the present invention is the provision for improved battery life in wireless medical devices by re-configuring the transmit power based on the required range of communication.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

FIG. 1 is an example implementation of a wireless medical device in accordance with the present invention.

FIG. 2 is flow chart depicting functions of an embodiment of the present invention.

FIG. 3 is a flow chart depicting functions of another embodiment of the present invention.

FIG. 4 is a block diagram of a dual class wireless communication module suitable for use in an embodiment of the present invention.

FIG. 5 is another block diagram of a sensor and remote receiver illustrating another aspect of the present invention.

FIG. 6 illustrates a multiple sensor environment utilizing a plurality of sensors in wireless communication with a remote device.

### DETAILED DESCRIPTION OF THE INVENTION

Embodiments of the present invention allow for improved battery life in wireless medical devices by re-configuring and optimizing transmit power based on a range of communication required for effective communication.

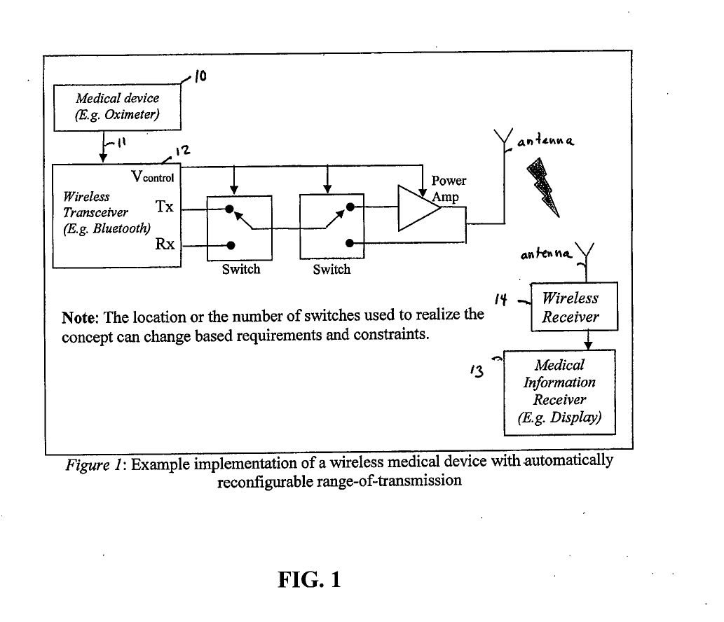

FIG. 1 illustrates an example implementation of a wireless medical device having automatic range-of-transmission reconfiguration capability and adapted to communication with remote receiver 13. Medical device 10 includes a sensor, such as, but not limited to, an oximeter, blood pressure sensor or temperature sensor. Device 10 is connected via line 11 to transceiver device 12. Transceiver device 12 may be physically separate from device 10 or may be integrated along with device 10 in a single unit. Transceiver 12 is in wireless communication with remote receiver 13, having wireless receiver (transceiver) 14.

In operation of one embodiment, transceiver 12 determines the quality of the communications link between transceiver 12 and remote receiver 13 using one or more communication parameters. Such parameters may include, but are not limited to, received signal strength, transmit power information and bit error rate. Once transceiver 12 determines the quality of the communications link with receiver 13, transceiver 12 or medical device 10 can configure one or more parameters of the transceiver circuit to improve or optimize the communications link in order to maintain communication stability while extending battery life of transceiver 12. For example, transceiver 12 or medical device 10 may utilize an internal algorithm to estimate a transmit power level required to reliably transmit data to receiver 13. In one embodiment, transceiver 12 controls the output power of the transmitter using one or a combination of several schemes, including, but not limited to, switches to enable or disable an external power amplifier, controlling the bias voltage of the power amplifier, etc).

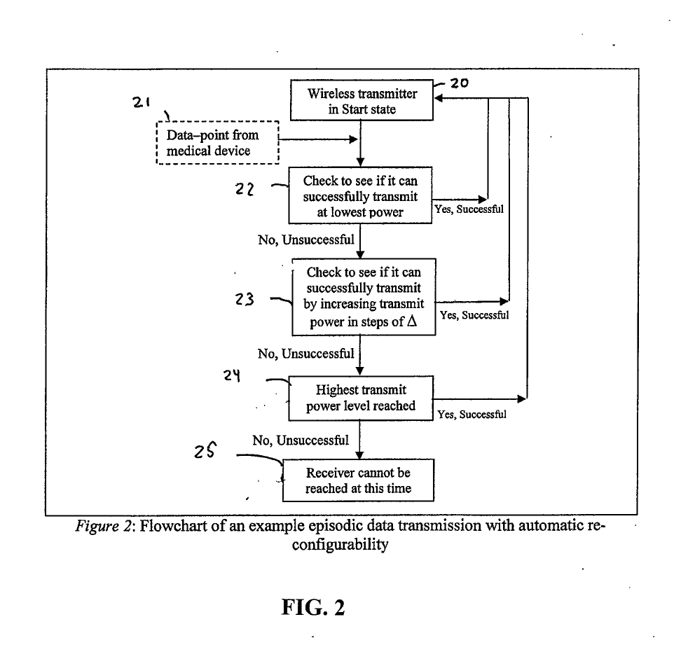

FIG. 2 illustrates a flowchart depicting functions of an embodiment of the present invention. In this example, data transfer is characterized as episodic. In episodic data transfer, a single measurement is transmitted during a session.

Wireless transceiver operation begins in at START state 20. Medical device 10 communicates a reading to wireless transceiver 12 at step 21. At step 22, the wireless transceiver initiates to a lowest power mode, e.g. power level A, and transmits a signal to receiver 13. If receiver 13 successfully receives the signal, receiver 13 transmits a signal back to medical device 10/transceiver 12. Communication of a signal at the lowest power mode is then commenced after which the wireless transceiver 12 returns to the START state. If receiver 13 does not receive the signal from transceiver 12, then transceiver 12 reconfigures a communication parameter by a predetermined level. In this example, transceiver 12 increases the transmit power incrementally in pre-set steps at step 23 and retests whether communication is successful. If communication is successful, transceiver 12 returns to the START state. If receiver 13 is unable to communicate with transceiver 12, even after transceiver reconfigures to a highest transmit power at step 24, then it is determined at step 25 that communication is unavailable at that particular time.

In the example of FIG. 2, the transceiver 12 incrementally increases the transmit power from a low level to a higher operable transmit level. In another embodiment, the transceiver could incrementally decrease the transmit power from a high level down to a lower operable transmit level utilizing a similar approach to that of FIG. 2.

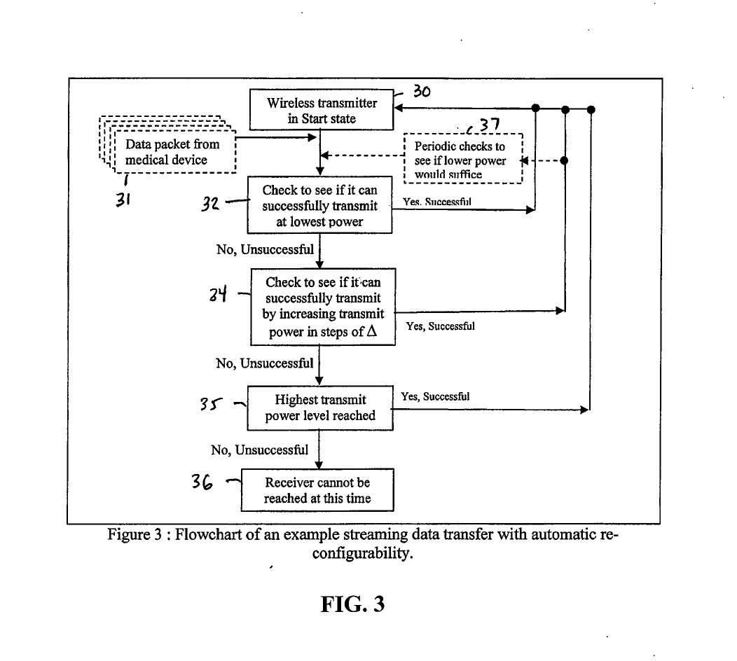

FIG. 3 illustrates a flowchart depicting functions of another embodiment of the present invention. In this example, data transfer is continuous or “streaming.”

Wireless transceiver 12 operation begins in a START state 30. Medical device 10 communicates packets of data to the wireless transceiver 12 at step 31. A packet of data is transmitted to receiver 13 with transceiver 12 at a lowest power mode and a determination is made at step 32 whether transmission is successful at the lowest power mode. If transmission is successful, wireless transceiver 12 returns to the start state and transmits subsequent data packets at the lowest power mode. If it determined at step 32 that the transmission was not successful, then transceiver 12 increases the transmit power by a predetermined step at 34. After each transmit level increase, a determination is made whether communication is successful. If after transceiver 12 increase transmit power to a maximum and the determination is made that communication is still unsuccessful at steps 35 and 36, then communication between receiver 13 and transceiver 12 is unavailable at that particular time. In this embodiment, periodic checks may be made at step 37 to determine if a lower power level would suffice.

In another embodiment of the present invention. A sensor may include, but is not limited to, a temperature sensor, a glucose sensor, a CO2 sensor, a blood pressure sensor, a pulse rate sensor, and an Sp02 sensor. In one embodiment, the sensor is a finger-tip positioned physiological sensor. The sensor communicates with a remote device, such as an in-room monitor, a care-provider server or a central data repository. The sensor, in one embodiment, communicates via BLUETOOTH protocol with the remote device.

In use, a patient finger is inserted in finger-tip sensor for monitoring physiological conditions of the patient. The sensor may automatically turn on upon finger insertion and then measure one or more of: temperature, blood glucose, CO2 level, SpO2, pulse rate, blood pressure, etc. At the same time, the sensor may determine the quality of the link using a communication parameter, such as, received signal strength, transmit power, bit error rate, etc. The device may then proceed to determine the appropriate configuration of the device's transceiver in order to communicate with the remote device with the optimum power requirement, e.g., effective bi-directional communication between the sensor and the device at the lowest power rate. The determination described above with reference to FIGS. 2 and 3 may be utilized.

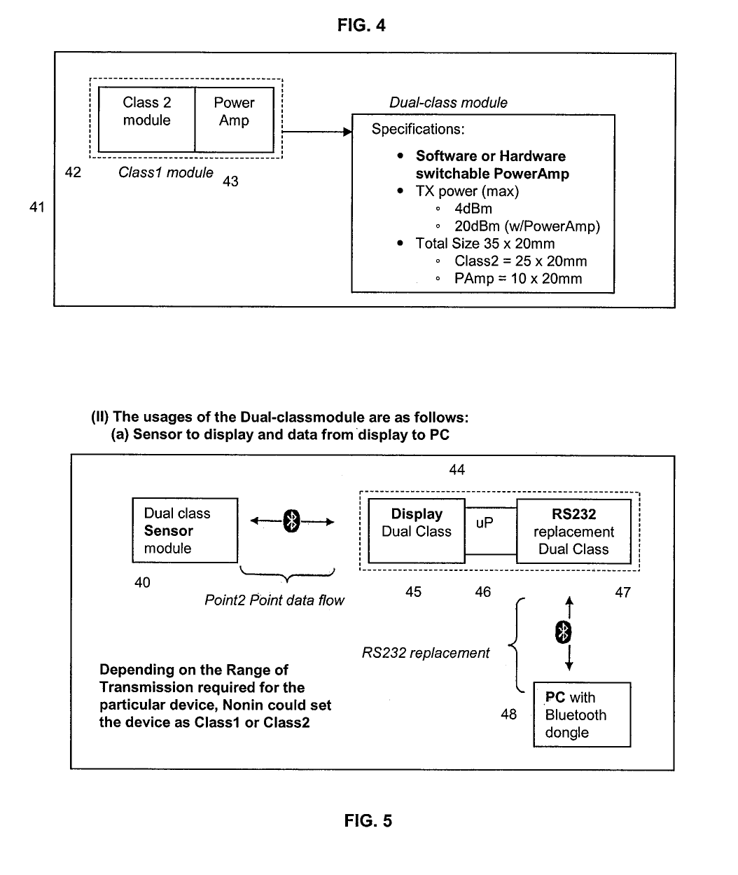

FIGS. 4 and 5 illustrate a block diagrams of another embodiment of the present invention. FIG. 4 illustrates a dual class sensor module 40 capable of implementation within a variety of portable physiological sensors. Module 40 includes a class 1 module 41 and a class 2 module 42, and a power amp 43 in operative connection with module 42. Module 40 may be implemented in hardware or software or both. The maximum transmission power of module 40 is 4 dBm and 20 dBm (with power amp 43 activated).

Referring to FIG. 5, dual class sensor module 40 is capable of wireless communication with a remote device 44. Remote device 44 includes a display 45, a microprocessor 46, an RS232 replacement module 47. Remote device 44 may communicate with another remote device 48, such as a BLUETOOTH enabled PC.

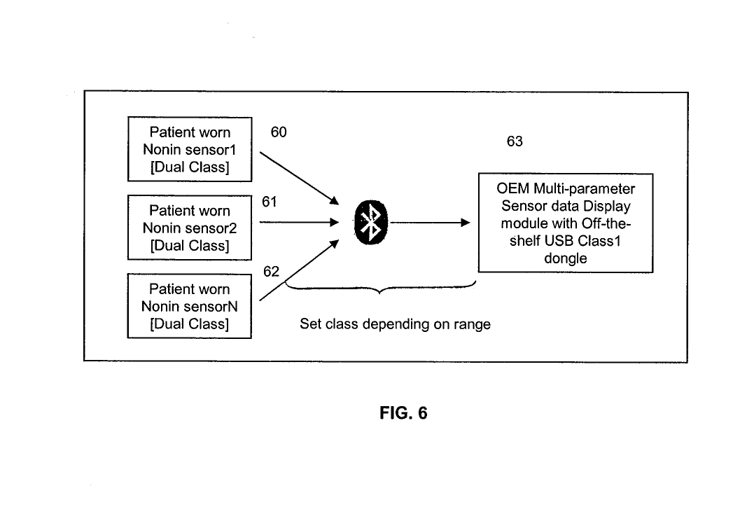

FIG. 6 illustrates a block diagram of another embodiment of the present invention wherein a plurality of sensors 60, 61, 62 are capable of independently communicating with a OEM Display Unit 63. Sensors 60-62 may include patient worn devices incorporating dual class modules, such as those of FIG. 4. Each sensor 60-62 may independently and periodically evaluate signal strength in order to minimize power requirements, etc., while maintaining effective communication between the sensor and the remote unit 63. Remote unit 63 may assume a variety of different configurations, including, but not limited to, a BLUETOOTH enable PDA/PC, etc.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of optimizing communication between a medical device and a remote medical information receiver comprising:
identifying a signal representing a physiological measurement at a medical device;
transmitting a test signal from a transceiver of said medical device to a remote medical information receiver at a location away from said medical device, said transmitting occurring with a predetermined communication parameter;
determining whether said test signal is received by said remote medical information receiver;
if said test signal is not received by said remote medical information receiver, adjusting said communication parameter to increase a likelihood that said test signal is received at said remote medical receiver; and
repeating said transmitting, determining, and adjusting until said test signal is received by the remote medical information receiver, and then transmitting said signal representing a physiological measurement to the remote medical receiver at said adjusted communication parameter.

2. The method of claim 1 wherein said communication parameter is one or more of: transmit power, receive sensitivity and antenna gain/direction.

3. The method of claim 1 wherein said adjusting results in a predetermined increase in a transmit power level.

4. The method of claim 1 wherein said changing results in a predetermined decrease in a transmit power level.

5. The method of claim 1 wherein said physiological measurement is a blood oxygen saturation measurement, a body temperature, or a blood pressure.

6. A method of optimizing communication between a medical device and a remote medical information receiver comprising:
transmitting a signal from a medical device toward a remote medical information receiver at a predetermined power level;
determining whether said signal is received by said remote medical information receiver;
incrementally changing said signal to a new power level, transmitting the signal at said new power level from the medical device toward the remote receiver, determining whether the signal is received by the remote receiver, and continuing with said increasing, transmitting and determining until the signal is received by the remote receiver; and
initiating data transfer at the new power level for which the signal was received by the remote receiver.

7. The method of claim 6 further comprising:
notifying a user that communication between the sensor and the remote receiver is unsuccessful after the incrementally changing signal level reaches a maximum or minimum signal level without successful transmission.

8. The method of claim 6 further comprising:
periodically evaluating a signal level in order to determine whether a lower signal level can be utilized to communicate between the sensor and the remote device.
